(19) United States
(12) Patent Application Publication
(10) Pub. No.: US 2020/0338845 A1
(43) Pub. Date: Oct. 29, 2020

(54) SYSTEMS, METHODS, AND DEVICES FOR MANUFACTURING EYEGLASS FRAMES

(71) Applicant: Liberty Sport, Inc., Fairfield, NJ (US)

(72) Inventors: Carmine S. DiChiara, Warren, NJ (US); Deni Crescenzi, Toronto (CA)

(21) Appl. No.: 16/859,271

(22) Filed: Apr. 27, 2020

Related U.S. Application Data
(60) Provisional application No. 62/840,090, filed on Apr. 29, 2019.

(51) Int. Cl. B29D 12/02; B29C 33/40; G02C 5/00; B29C 45/04

(52) U.S. Cl. CPC B29D 12/02; B29C 45/04; G02C 5/008; B29C 33/40

(57) ABSTRACT

An assembly for injection molding eyeglass frames is provided including a mold having a mold interior and a mold insert located within the mold interior. The insert has an insert body that seals the mold interior and forms a mold channel when the mold is closed, and an insert edge that extends into the mold channel. The insert edge has a first side, a second side, and a boundary, and the first side follows a surface trajectory of a corresponding side of the insert body, and the second side tapers towards the first side. Also provided is an insert for use in the assembly and glasses formed using the assembly.

### CROSS-REFERENCE TO RELATED APPLICATION

This application claims the benefit of U.S. Provisional Application No. 62/840,090, filed on Apr. 29, 2019, the contents of which are incorporated by reference herein.

### FIELD OF THE INVENTION

This disclosure relates generally to manufacturing glasses frames, and more specifically, to methods and devices for manufacturing eyeglass frames by injection molding.

### BACKGROUND

When injection molding eyeglass frames, there are substantial challenges associated with forming a lens groove in an interior surface of such frames. Traditional injection molding methods make it very difficult to mold an interior channel, particularly in the context of a relatively delicate part, such as a thin component of eyeglass frames.

However, it is necessary to provide such lens grooves in order to retain lenses in the frames once assembled. Further, it is important for the lens groove to have walls that are shaped to securely retain lenses such that lenses are not easily dislodged or displaced by an impact. This is particularly true in sport eyeglass frames which may be rated to withstand impacts during sporting activities. For example, frames meeting the ASTM F803 standard for impact resistance must be able to retain lenses and withstand specified levels of impact. Accordingly, a frame conforming to such a standard may be required to withstand an impact from a ball without breaking or ejecting lenses towards a wearer's eyes.

Traditionally, due to the difficulty of molding a lens groove into injection molded eyeglass frames, various techniques have been used to incorporate such grooves. In some cases, an insert is provided within a mold cavity to form the groove. In such cases, the insert is located within the injection mold, the mold is closed around the insert, and the insert and the mold form a channel into which plastic material is injection molded. In such a case, an outer edge of the insert extends into the molding channel, thereby forming a groove in the molded plastic. Upon cooling, the insert is then removed from the groove by simply pulling the insert out of the molded frame, or by pulling the molded frame off of the insert.

In order to avoid damaging the frame while removing the insert in such methods, the insert is removed while the frame is still cooling and the edges of the insert are tapered, forming a V shaped groove. Such a taper is necessary to allow the removal of the insert while minimizing the risk of damaging the frames during such removal.

The resulting V shaped grooves ease the removal of the insert during the molding process. However, the V shape also similarly reduces the frames' ability to retain lenses under impact.

In some cases, deeper grooves or more secure groove geometries have been provided by including a split in the frame when molded. Accordingly, such frames may be able to open in order to eject the mold insert and to accept lenses. However, such frames are more complicated, as they require retention systems for tensioning the split in the frame which in turn requires additional manufactured components. Further, a split frame is less structurally stable than a single piece molded component.

There is a need for an injection molding system, device, and method for providing a lens groove geometry in an injection molded frame that can retain a lens under impact. Further, there is a need for such a lens groove geometry in which an impact sufficient to dislodge a lens from a lens groove is made more likely to eject such a lens away from a wearer's eyes.

### SUMMARY

An assembly is provided for injection molding eyeglass frames. The assembly comprises a mold containing a mold interior; and a mold insert located within the mold interior. When the mold is closed the mold interior and the mold insert form a mold channel and thereby define the mold cavity. The insert comprises an insert body that seals the mold interior thereby forming a mold channel when the mold is closed and an insert edge extending into the mold channel. The insert edge has a first side, a second side, and a boundary, and the first side follows a surface trajectory of a corresponding side of the insert body and the second side tapers towards the first side.

Typically, the boundary is substantially perpendicular to the first side of the insert edge and the second side has a tapered segment that tapers towards the first side. In some embodiments, the second side also has a flat section substantially parallel to the first side directly adjacent the boundary.

In some embodiments, at least one side of the insert body has a curvature corresponding to an expected lens curvature. As such, the first side of the insert edge may be on a concave side of the curvature of the insert body and the second side may be on a convex side of the insert body.

The first side of the insert edge may be adjacent a portion of the mold for forming a back side of the pair of glasses, and the second side of the insert edge may be adjacent a portion of the mold for forming a front side of the pair of glasses.

In some embodiments, the insert body may be a single element. In other embodiments, the insert body may comprise a plurality of insert components, and the plurality of insert components abut each other when the mold is closed. In such an embodiment, the insert components may be fixed to the interior of the mold, such that at least one component is fixed to a mold core portion of the mold interior and at least one component is fixed to a mold cavity portion of the mold interior.

In some embodiments, the insert body may have a substantially consistent thickness for sealing the mold interior.

Also provided are an insert incorporating the geometry described above and a glasses frame formed using the mold assembly described.

### BRIEF DESCRIPTION OF THE DRAWINGS

FIGS. 1A and 1B show two halves of a mold having mold inserts for use in the system of this disclosure.

FIGS. 2A and 2B show a second embodiment of two halves of a mold having mold inserts for use in the system of this disclosure in a first configuration.

FIGS. 2C and 2D show the second embodiment of the two halves of the mold having the mold inserts of FIGS. 2A and 2B in a second configuration.

FIG. 3A is a schematic diagram showing a potential edge profile for the mold inserts of FIGS. 1A and 2A-D.

FIG. 3B is a schematic diagram showing a second potential edge profile for the mold inserts of FIGS. 1A and 2A-D.

FIG. 4 is a perspective view of a lens groove in a frame formed using the mold inserts of FIG. 2A-D and having the edge profile shown in FIG. 3B in accordance with this disclosure.

FIG. 5 is a sectioned view of a lens groove in a frame taken along line 5-5 in FIG. 4.

### DETAILED DESCRIPTION OF THE PREFERRED EMBODIMENTS

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the exemplified embodiments. Accordingly, the invention expressly should not be limited to such exemplary embodiments illustrating some possible non-limiting combination of features that may exist alone or in other combinations of features; the scope of the invention being defined by the claims appended hereto.

This disclosure describes the best mode or modes of practicing the invention as presently contemplated. This description is not intended to be understood in a limiting sense, but provides an example of the invention presented solely for illustrative purposes by reference to the accompanying drawings to advise one of ordinary skill in the art of the advantages and construction of the invention. In the various views of the drawings, like reference characters designate like or similar parts.

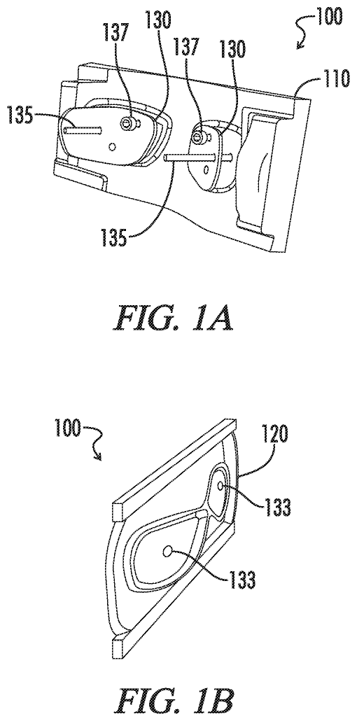

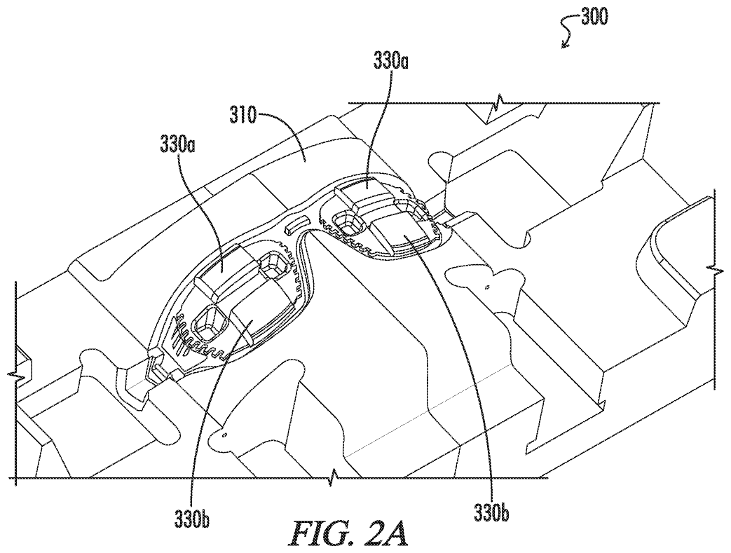

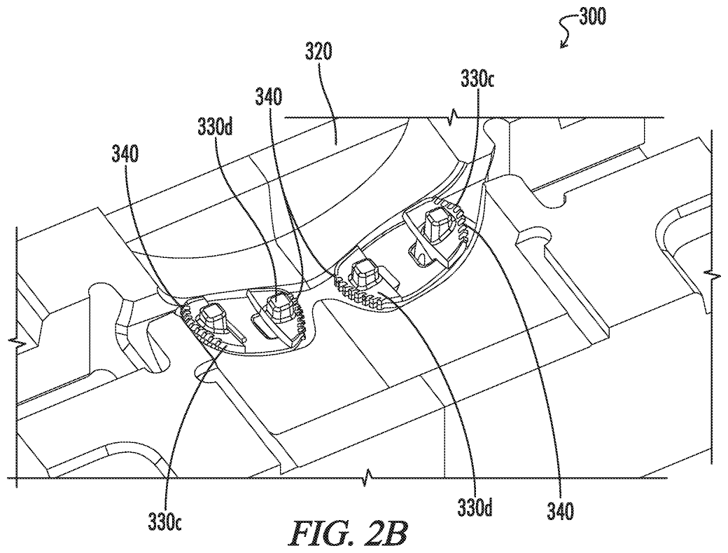

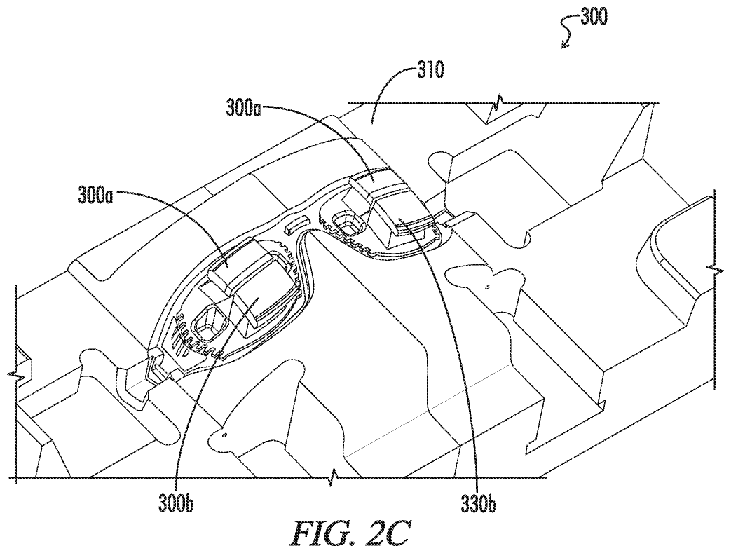

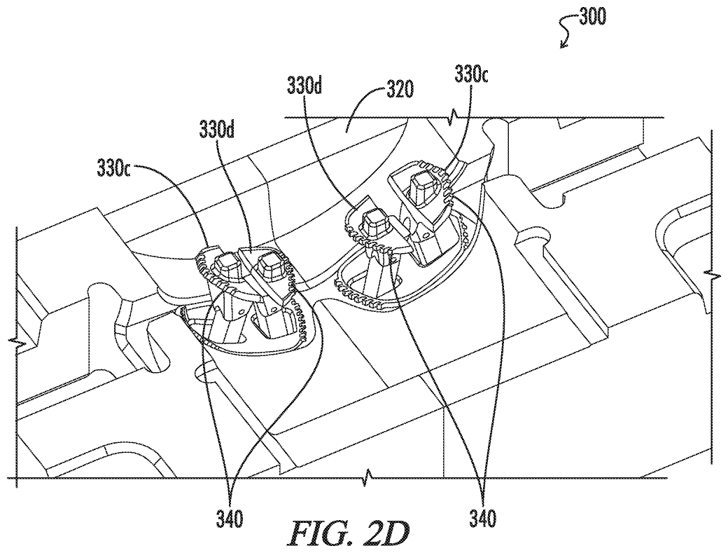

FIGS. 1A and 1B show two halves 110, 120 of a mold assembly 100 having mold inserts 130 for use in the system of this disclosure. FIGS. 2A and 2B show a second embodiment of two halves 310, 320 of a mold assembly 300 having mold insert components 330a, b, c, d for use in the system of this disclosure in a first configuration. FIGS. 2C and 2D show the second embodiment of the two halves 310, 320 of the mold assembly 300 having the mold insert components 330a, b, c, d of FIGS. 2A and 2B in a second configuration.

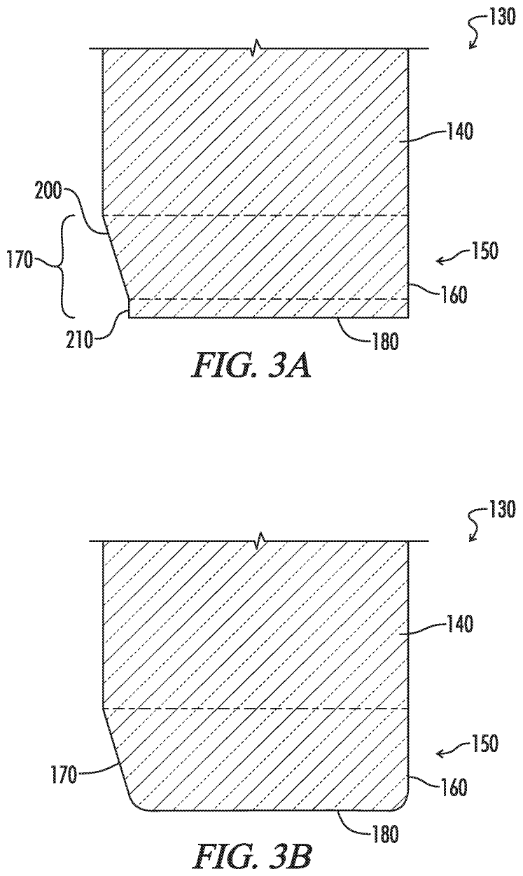

FIG. 3A is a schematic diagram showing a potential profile for the mold inserts 130 of FIG. 1A or the combined mold insert components 330a, b, c, d of FIGS. 2A-D.

FIG. 3B is a schematic diagram showing a second potential profile for the mold inserts 130 of FIG. 1A or the combined mold insert components 330a, b, c, d of FIGS. 2A-D.

As shown, the mold assembly 100 for injection molding eyeglass frames provided comprises a mold core 110 and a mold cavity 120 which combine to form a mold. At least one mold insert 130 is provided such that the insert is located within the mold cavity 120 when the mold assembly 100 is closed. Typically, as shown, two mold inserts 130 are provided to form two eye holes in eyeglass frames being molded. It will be understood that in this disclosure, the mold core 110 and the mold cavity 120, when closed, are occasionally referred to together as a mold, with an interior space of the closed mold being referred to as a mold interior.

In order to ensure that the mold is properly aligned when closed, the mold core 110 may be provided with guide pins 135. Such guide pins are inserted into holes 133 in the mold cavity 120 when closing the mold. The guide pins 135 may pass through the mold inserts 130.

As shown in FIG. 1A, the mold inserts 130 are fixed to mold core 110 using supports 137, such as the bolts shown. In some embodiments, the mold inserts 130 are stationary relative to the mold core 110 and fixed in place in order to provide consistent results during the molding process. In alternate embodiments, the inserts may be slightly rotatable in multiple dimensions about the corresponding supports 137 to ease the removal process. In order to ensure that the mold inserts 130 are consistently located in the mold when closed, any such movement may be minimal and may be spring loaded. In such an implementation where the mold inserts 130 are rotatable, such rotation will force the mold insert out the front of the lens groove.

FIGS. 2A-2D show a second embodiment of a mold assembly 300 for use in the system of this disclosure. As shown, the mold assembly 300 comprises a mold core 310 and a mold cavity 320 which combine to form a mold. A set of mold insert components 330a, b, c, d combine to form a combined mold insert such that the combined mold insert is located within the mold cavity 320 when the mold assembly 300 is closed. As shown, two combined mold inserts 330a, b, c, d are provided to form two eye holes in eyeglass frames being molded.

When the mold assembly 300 is closed, the mold insert components 330a, b, c, d are pressed against the mold core 310 and mold cavity 320 and abut each other, thereby forming the combined mold inserts. As shown, at least one mold insert component 330a, b may be fixed to the mold core 310 while at least one other mold insert component 330c, d, may be fixed to the mold cavity 320. Accordingly, when the mold core 310 and the mold cavity are separated, the corresponding mold insert components 330a, b, c, d may extend from their respective mold components 310, 320, thereby easing the removal of a glasses frame from the mold assembly 300.

As shown in the embodiment of FIGS. 1A-B, and in more detail in FIGS. 3A-B, each insert 130 may comprise an insert body 140 having a substantially consistent thickness that creates a seal between the mold cavity 120 and the mold core 110 when the mold assembly 100 is closed. Accordingly, when the mold assembly 100 is closed, the mold cavity 120, the mold core 110, and the insert body 140 combine to form a mold channel (not shown). The mold channel forms the shape of the eyeglass frames being molded.

As shown in FIGS. 3A-B, the mold insert 130 has an insert edge 150 which comprises a circumference fully surrounding the insert body 140 that extends into the mold channel when the mold assembly 100 is closed. Accordingly, the insert edge 150 forms a lens channel or groove in the mold channel during molding.

The insert edge 150 has a first side 160, a second side 170, and a boundary 180. The first side 160 follows a surface trajectory of a corresponding side of the insert body 140, and the second side 170 tapers towards the first side. As shown in FIG. 3A, the boundary 180 may be substantially perpendicular to the first side 160 of the insert edge 150.

Further, the second side 170 of the insert edge 150 taken as a whole tapers towards the first side 160. Accordingly, as shown in FIG. 3B, the second side 170 may form an obtuse angle with the boundary 180. However, in some embodiments, such as that shown in FIG. 3A, the second side 170 of the insert edge 150 may comprise a tapered segment 200 that tapers towards the first side 160 and a flat section 210 that is substantially parallel with the first side 160 and is therefore similarly perpendicular to the boundary 180. Such a flat section 210 provides an additional retention feature which may improve the ultimate retention of an eyeglass lens in the frame. However, some embodiments may provide a tapered segment 200 that extends fully to the boundary 180, such as that shown in FIG. 3B.

While the first side 160 is described as being substantially perpendicular to the boundary 180, and the second side 170 forms an obtuse angle with the boundary, it will be understood that the first side 160 may similarly form an obtuse angle. However, in any event, the angle between the boundary 180 and the first side 160 is smaller than the angle between the boundary 180 and the second side 170.

Similarly, the angles between the sides 160, 170 and the boundary 180 may form sharp corners, as shown in FIG. 3A, or they may be rounded as shown in FIG. 3B.

In typical embodiments, during use for the molding of eyeglass frames, the mold insert 130 is located within the frame being molded in the location in which a lens would ultimately be located within the frame. Accordingly, the insert edge 150 corresponds to the location of a lens edge located within a lens groove. The insert body 140 may therefore have a curvature similar to that of an expected glasses lens curvature. This is shown in FIG. 1A, and the mold insert 130 therefore has a concave side and a convex side. In such a mold assembly 100, the concave side would typically correspond to the back of a frame and the convex side would correspond to the front of the frame, such that the concave side of the insert body 140 would correspond to the side of a lens that will ultimately be closest to a wearer's eyes.

In such an embodiment, the first side 160 of the insert edge 150 would then be on the concave side of the insert body 140 and the second side 170 of the insert edge would be on the convex side of the lens insert.

Regardless of the curvature of the insert body 140, the first side 160 of the insert edge 150 discussed above would be located adjacent a portion of the mold for forming a back side of a pair of glasses, and the second side 170 of the insert edge would be located adjacent a portion of the mold for forming a front side of a pair of eyeglasses.

Although the mold insert edge geometry is discussed at length with respect to the mold insert 130 of the mold assembly 100 of FIG. 1A, the same mold insert edge geometry may be applied to the mold insert components 330a, b, c, d of the mold assembly 300 of FIG. 2A-D. Accordingly, while the insert components 330a, b, c, d may take different forms, each component has an insert edge 150 taking the same form as that discussed above with respect to FIG. 3A-B. Accordingly, for each insert component 330a, b, c, d, an insert edge 150 is provided at an outer boundary of the component. Accordingly, when the mold assembly 300 is closed and the insert components 330a, b, c, d are combined into the combined mold inserts, the mold cavity 320, mold core 310, and a portion of the combined mold inserts combine to form a mold channel. The insert edge 150 then fully surrounds the corresponding combined mold insert 330a, b, c, d and extends into a mold channel when the mold assembly 300 is closed.

The insert edge 150 therefore forms a lens channel or groove in the mold channel during molding, as discussed with respect to FIGS. 1A-B and 3A-B. It is noted that the insert edge 150 may extend entirely around a boundary of the mold insert 130 as shown in FIG. 1A. Alternatively, in some embodiments, the insert edge 150 may be provided with gaps or extensions 340, such as where gaps in the corresponding frame and mold channel may be provided. This is shown, for example, in the mold insert components 330c, d of the mold assembly 300 shown in FIGS. 2B and 2D, for example. The extensions 340 shown in FIGS. 2A-B correspond to vents in the completed frame, which in turn correspond to gaps in the mold channel.

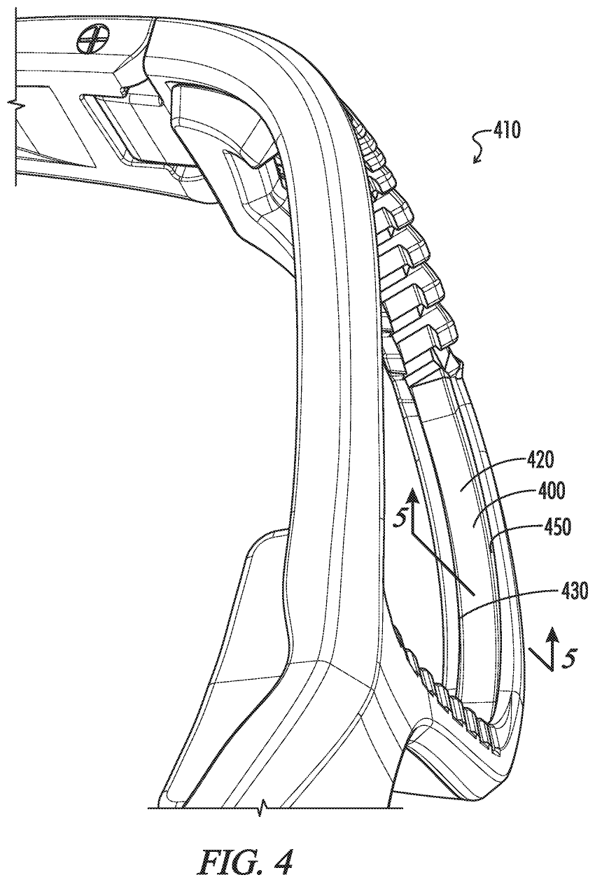

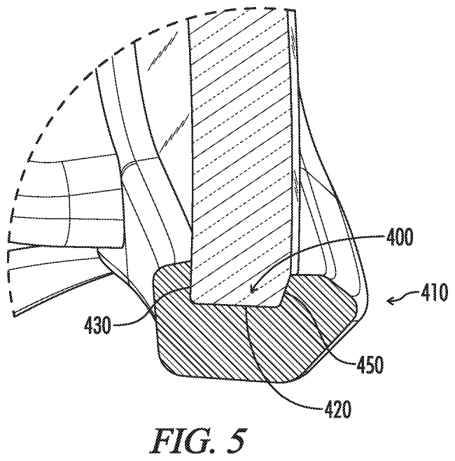

FIG. 4 is a perspective view of a lens groove 400 in a frame 410 formed using the mold insert 140 of FIG. 2A in accordance with this disclosure. FIG. 5 is a section view of the lens groove 400 in a frame 410 in accordance with this disclosure. As shown, the lens groove 400 has a boundary surface 420 and a first wall 430 perpendicular to the boundary surface at the rear portion of the frame. The lens groove 400 has a second wall 440 with a first segment 450 tapered towards the first wall 430. In some embodiments, the second wall 440 of the lens groove has a second segment parallel to the first wall 430 and substantially perpendicular to the boundary surface 420 at the front portion of the frame 410. As shown the second wall has a tapered segment 450 extending to the boundary surface 420, thereby meeting the boundary surface at an obtuse angle.

Further, as shown in FIG. 5, the first wall 430 may be taller than the second wall 440, thereby providing a taller lip on the back portion of the frame. Typically, the first wall 430 may be between 0.3 and 0.5 mm taller than the second wall 440.

In some embodiments, an ejection mechanism for ejecting the mold inserts 130 shown in FIG. 2A, may be provided. In molding the glasses frames shown, when the mold is opened, ejector pins typically push the frame 410 in order to push the frame off the back of the mold inserts 130 such that the lenses insert exits through the front of the frame.

As discussed above, in some embodiments, the mold inserts 130 are slightly rotatable relative to the mold core 110, such as by spring loading. In such an embodiment, the mold inserts 130 can rotate and swivel about the supports 137. Accordingly, when the mold is opened, the mold insert 130 rotates about the supports 137 by virtue of the spring force applied. In this way, the mold insert 130 is rotated out of the lens channel formed during the molding process. As discussed above, and as shown in FIG. 5, the first wall 430 is typically taller than the second wall 440, while the second wall is tapered. In any such embodiment, the rotation of the lens insert forces such an insert out the front of the frame 410.

This slight rotation of the mold inserts 130 may work in concert with the ejector pins pushing the front of the frame 410, forcing the frame off the back of the inserts.

Because the channel was formed by the first side 160 and the second side 170 of the insert edge 140, and because the second side is tapered towards the first side, the mold insert 130 ejects through the front of the molded glasses frame, which corresponds to the tapered side of the mold edge. Accordingly, any weakening of the frame associated with the injection molding process would be to the front of the frame. The front of the frame is also provided with the tapered portion of the lens groove 400.

Accordingly, during use of the eyeglass frames 410 manufactured using the system and method described, the rear portion of the lens groove 400 corresponding to the first wall 430 remains perpendicular to the boundary surface 420. Further, in some embodiments, such as that formed from the profile shown in FIG. 3A, at least a small segment of the second wall is similarly perpendicular to the boundary surface 420. With this structure of the lens groove 400, most impacts would not dislodge glasses lenses from the frames 410. Further, if a particularly severe impact were to dislodge such lenses from the frames 410, it would be through the tapered second wall 450 of the lens groove 400, and the lenses would therefore exit the frames through the front, away from a wearer's eyes.

While the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

What is claimed is:

1. An assembly for injection molding eyeglass frames, the assembly comprising:
a mold containing a mold interior; and
a mold insert located within the mold interior,
wherein, the insert comprises:
an insert body that seals the mold interior forming a mold channel when the mold is closed, and
an insert edge extending into the mold channel,
wherein the insert edge has a first side, a second side, and a boundary, and wherein the first side follows a surface trajectory of a corresponding side of the insert body, and wherein the second side tapers towards the first side.

2. The assembly of claim 1, wherein the boundary is substantially perpendicular to the first side of the insert edge.

3. The assembly of claim 1, wherein the second side of the insert edge has a tapered segment that tapers towards the first side and a flat section substantially parallel to the first side directly adjacent the boundary.

4. The assembly of claim 1, wherein the mold cavity is defined by the mold and the insert body.

5. The assembly of claim 1, wherein at least one side of the insert body has a curvature corresponding to an expected lens curvature.

6. The assembly of claim 5, wherein the first side of the insert edge is on a concave side of the curvature of the insert body and wherein the second side of the insert edge is on a convex side of the insert body.

7. The assembly of claim 1, wherein the first side of the insert edge is adjacent a portion of the mold for forming a back side of a pair of glasses, and wherein the second side of the insert edge is adjacent a portion of the mold for forming a front side of a pair of glasses.

8. The assembly of claim 1, wherein the insert body comprises a plurality of insert components, and wherein the plurality of insert components abut each other when the mold is closed.

9. The assembly of claim 8, wherein at least one of the insert components is fixed to a mold cavity portion of the mold interior and at least one of the insert components is fixed to a mold core portion of the mold interior.

10. The assembly of claim 1, wherein the insert body has a substantially consistent thickness for sealing the mold interior.

11. An insert for an injection mold assembly, the insert comprising:
an insert body for sealing a mold interior when a corresponding mold is closed; and
an insert edge extending into the mold cavity,
wherein the insert edge has a first side, a second side, and a boundary, and wherein the first side follows a surface trajectory of a corresponding side of the insert body, and wherein the second side tapers towards the first side.

12. The insert of claim 11, wherein the boundary is substantially perpendicular to the first side of the insert edge.

13. The insert of claim 11, wherein the second side of the insert edge has a tapered segment that tapers towards the first side and a flat section substantially parallel to the first side adjacent the boundary.

14. The insert of claim 11, wherein the insert body has a curvature corresponding to an expected lens curvature.

15. The insert of claim 14, wherein the first side of the insert edge is on a concave side of the curvature of the insert body and wherein the second side of the insert edge is on a convex side of the insert body.

16. The insert of claim 11, wherein the first side of the insert edge is adjacent a portion of the mold for forming a back side of a pair of glasses, and wherein the second side of the insert edge is adjacent a portion of the mold for forming a front side of a pair of glasses.

17. The insert of claim 11, wherein the insert body comprises a plurality of insert components, and wherein the plurality of insert components abut each other when the corresponding mold is closed.

18. The insert body of claim 17, wherein at least one of the insert components is fixed to a mold cavity portion of the corresponding mold, and wherein at least one of the insert components is fixed to a mold core portion of the corresponding mold.

19. Glasses frames having a lens groove, wherein the lens groove comprises:
a boundary surface;
a first wall substantially perpendicular to the boundary surface adjacent a rear side of the glasses frames;
a second wall forming an obtuse angle with the boundary surface and opposite the boundary surface from the first wall.

20. The glasses frames of claim 19, wherein the second wall further comprises a first segment forming the obtuse angle with the boundary surface and a second segment substantially perpendicular to the boundary wall, and wherein the second segment is directly adjacent the boundary surface and is between the first segment and the boundary surface.
